(19) United States
(12) Patent Application Publication
(10) Pub. No.: US 2010/0049477 A1
(43) Pub. Date: Feb. 25, 2010

(54) CIVIL ENGINEERING SIMULATION USING QUADTREE DATA STRUCTURES

(75) Inventor: Shlomo SIVAN, Herzelia (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: Sivan Design D.S Ltd, Rananna (IL)

(21) Appl. No.: 12/539,631

(22) Filed: Aug. 12, 2009

Related U.S. Application Data
(60) Provisional application No. 61/089,916, filed on Aug. 19, 2008.

(51) Int. Cl. G06F 17/50

(52) U.S. Cl. 703/1

(57) ABSTRACT

A 3D visual realization system and method of use thereof. The system operatively interfaces to a CAD application and converts the design data to models that are then stored in Quadtree data structures in a database. A graphic engine streams the data out of the database. The graphic engine decides which data segments are required, fetches the required data and displays the data on the designated media. Smart management of the computer memory including keeping handy and relevant in the memory, and ability to provide a high frame rate enables smooth display of the 3D visual realization of the project. The 3D visual realization system and method further includes a method to cut out selected regions of a topographical mesh and replacing each region by implanting a redesigned graphical presentation of the extracted region.

### FIELD OF THE INVENTION

The present invention relates to a system and methods for simulating civil engineering projects and more particularly, the present invention relates to methods for simulating complex and large scale civil engineering projects, using Quadtree data structures.

### BACKGROUND OF THE INVENTION AND PRIOR ART

Quadtree data structures are used, for example, in flight simulators to store data representing large geographic data cells. In the flight simulators the geographic data cells are substantially even in size and contain a relatively small amount of features having uniform distribution.

There is a need and it would be advantageous to have a system and method for generating 3D visual realization of a large scale engineering design of a civil engineering project, such as infrastructure projects (roads, sewage systems, etc.).

Often, when designing a new longitudinal feature, such as a road, on a given topographical mesh, the integration of the mesh with the new design, due to local considerations, it is not clear which polygon should be displayed on top, resulting in an unstable flickering graphical display of the design Reference is made to FIG. 8, which depicts an exemplary integration 300 of an existing topographical model 20, integrated with a new topographical design 360 of a new road project, showing the unstable interlacing problem. While it is desirable to view topographical model 20 with a stable overlay of new engineering design 360, parts of topographical model 20, being at a higher topological elevation, are shown instead of new engineering design 360.

There is therefore a further need for a method that overcomes the unstable graphical display described hereabove.

### SUMMARY OF THE INVENTION

According to teachings of the present invention there is provided a system and method for generating 3D visual realization of a computer-aided design (CAD) system, including complex and large scale civil engineering projects.

According to further teachings of the present invention there is provided a method for integrating a new civil engineering design into a given topographical mesh, the method including cutting out a selected region in the topographical mesh and implanting the new design to replace the cutout region.

An aspect of the present invention is to provide a method for storing geographic data and engineering design in Quadtree data structures.

An aspect of the present invention is to provide Quadtree data structures for civil engineering projects taking place in a large geographical region. The geographical region is divided to geographical cells, having variable dimensions, whereas the dimensions of a geographical cell is decided by the amount of its elements which the cell model is made of (points/triangles), rather than the physical size. When a geographical cell reaches a preset maximal size (that is, amount of elements), the cell is subdivided into 4 new cells.

An aspect of the present invention is to store features in a geographical cells in importance order, thereby the important features can be fetch quickly.

An aspect of the present invention is to provide a graphic engine that continuously interacts with the database and the CAD design to generate a 3D visual realization of the CAD design.

### BRIEF DESCRIPTION OF THE DRAWINGS

The present invention will become fully understood from the detailed description given herein below and the accompanying drawings, which are given by way of illustrations and examples only and thus not limitative of the present invention, and wherein:

FIG. 1 is an exemplary schematic block diagram of a 3D visual realization system for a CAD design, according to embodiments of the present invention;

FIG. 2 is a schematic illustration of the method of storing data of a camera environment, according to aspects of the present invention;

FIG. 3 depicts an exemplary triangulation irregular network (TIN), representing the topography of a selected geographical region;

FIG. 4 depicts the exemplary TIN shown in FIG. 3, wherein the selected region to be replaced by a new design, is marked;

FIG. 5 depicts the exemplary TIN shown in FIG. 4, wherein the marked region and its immediate surroundings, are re-triangulated;

FIG. 6 depicts the exemplary TIN shown in FIG. 5, wherein the marked region is cut out;

FIG. 7 depicts the exemplary TIN shown in FIG. 6, wherein a new graphical design is implanted to replace the cutout region;

FIG. 8 depicts an exemplary integration of an existing topographical model with a new design of a new road project, showing the display unstable interlacing problem;

FIG. 9 depicts an exemplary topographical model, from which a selected region has been cut out; and

FIG. 10 depicts the cutout topographical mesh shown in FIG. 8, wherein a new design is implanted to replace the cutout region.

### DETAILED DESCRIPTION OF THE PRESENT INVENTION

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided, so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The methods and examples provided herein are illustrative only and not intended to be limiting.

By way of introduction, the principal intention of the present invention includes providing a 3D visual realization system and method for a CAD design. The method may further include cutting out selected regions of a topographical mesh and replacing each region by implanting a redesigned graphical presentation of the extracted region.

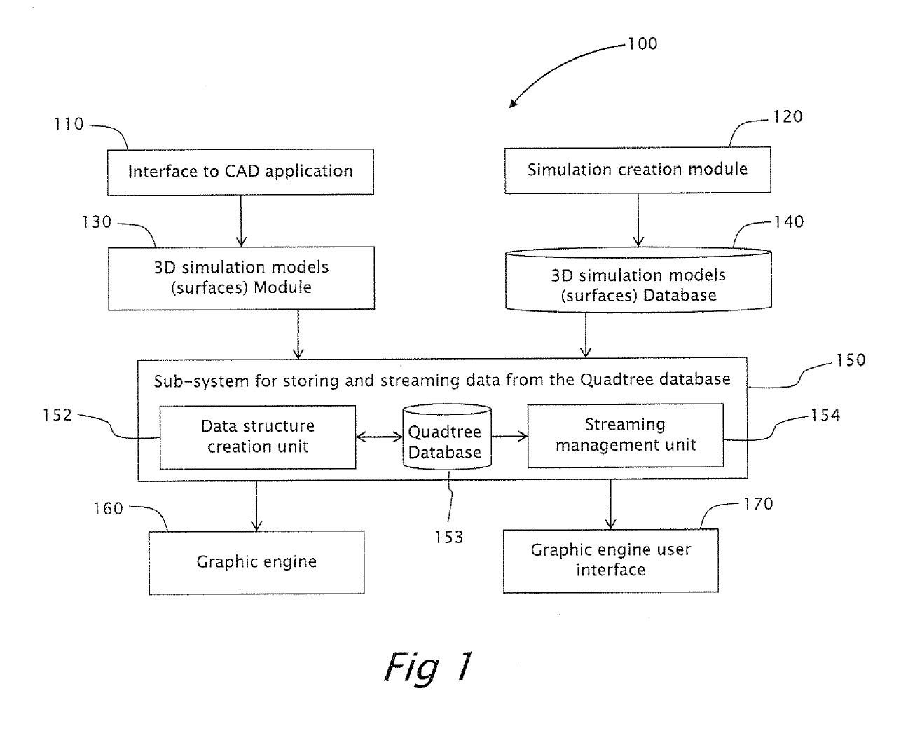

Reference is now made to FIG. 1, which is an exemplary schematic block diagram of system 100 for 3D visual realization of CAD designs, according to variations of the present invention. 3D visual realization system 100 is a universal computer executable program tool that can interface with substantially all common CAD designs systems. System 100 generates the 3D visual realization from the CAD application. Furthermore, system 100 can also generate a 3D visual realization of the existing geographical neighborhoods in which the project, being design in the CAD application, inheres. Any change in the CAD design will entail an immediate realization of the change in the 3D visual realization.

System 100 features one or more of the following capabilities.
a) Immediate 3D visualization of a CAD design at any stage of the design.
b) High accuracy of features presentation.
c) Visualization of projects constructed from large cells, including highway interchanges, bridges, multiple-lanes roads, neighborhoods spreading over hundreds of square kilometers.
d) Dealing with cells covering areas containing millions of triangles.
e) Integrating the 3D visual realization of the project being design in the CAD application, and the geographical neighborhoods in which the project inheres.
f) Enable viewing a certain region from various view points (perspective views, birds view, etc.).
g) Enable visual realization of motion, such as vehicles on a road.
h) Safety controls features such as realizing field of views of drives on a road.
i) Visual realization of whether and other elements that may affect design features of a project.
j) Visual realization of existing infrastructures.
k) Visual realization of various construction stages of a project.

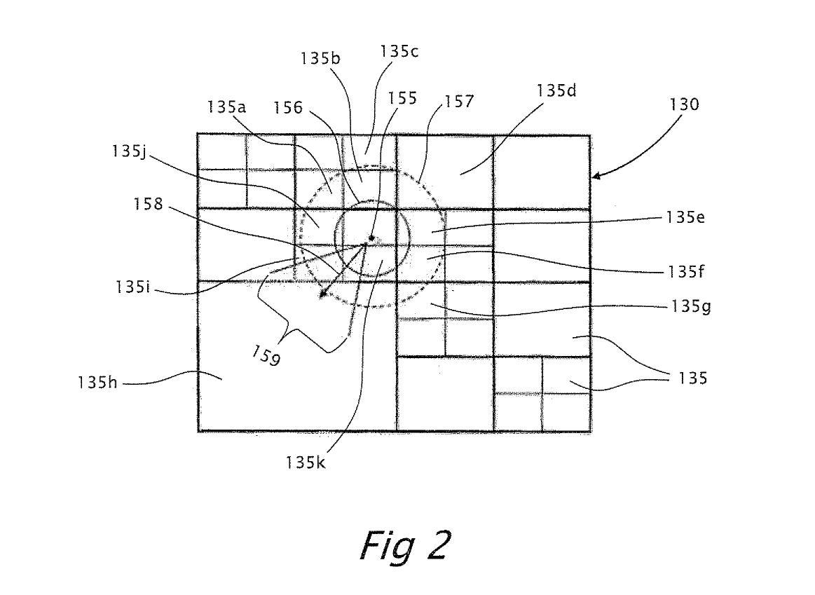

3D visual realization system 100 includes the following blocks:
Block 110: interface to CAD application.
   Converting from the CAD data, for example data in LandXML protocol, to the internal structure of the data structures of system 100. Missing features are computed according to a set of rules, for example civil engineering rules.
Block 120: simulation creation module.
   Forms simulating definitions based on the engineering design and the geographical neighborhoods data. Other tasks: defining camera locations, tying and adapting orthophotos, filtering and setting existing objects in the geographical neighborhood of the projects and more.
Block 130: 3D simulation models (surfaces) Module.
   Accurate modeling of objects in the geographical neighborhood in which the project inheres. Typically, the surface is modeled by triangulated irregular network (TIN). Special objects may be modeled by special algorithms. For example: modeling curbstones that were not modeled by the CAD system. The geographical neighborhood modeling may also include natural or manmade objects lying on the modeled terrain.
Block 140: 3D simulation models (surfaces) Database.
   The database is a Quadtree based database, which enables storing data of large scale terrain and other geographical and civil-engineering data, having non-uniform distribution. The data is stored in a manner that enables fast fetching and thereby enables streaming of the 3D visual realization.
   The project is subdivided into geographic data cells represented by a Quadtree data structure. The dimensions of a geographical cell are decided by the amount of features the cell contains, rather than the dimensions of the geographical area the cell covers. Hence, system 100 provides a more efficient method to handle data, having non-uniform distribution. When a geographical cell reaches a preset maximal size, the cell is subdivided into 4 new cells. Typically, in each “new” (undivided) cell contains a link to a file containing the data of the project portion the cell represents. This enables fast locating and fetching of the data.
Block 150: database managing sub-system.
   The data managing sub-system 150 stores and streams data to and from database 140. The preferred embodiment includes the following two main sub-systems that manage the streaming of data, to provide BD visual realization of the project at hand:
   Block 152: data structure creation unit.
      Manages the creation of Quadtree data structures, and the storing of data in a Quadtree database 153. The stored data includes the association of textural data to the respective object and handling objects that are represented by more than one Quadtree data structure. When line or areal objects are modeled by TIN, triangles that have vertices that appear in more than one cell are cut out. In such case, data structure creation sub-system 152 analyzes the influence of the cutting of a triangle and adjusts the data with the right level of details (LOD) in the cells involved such that smooth and efficient streaming of data will be attainable. It should be noted that keeping uniform LODs on the boundaries of the cells, in order to avoid “cracks” between cells with different LODs.
      Data is stored in the database such that continuity of objects is preserved over multiple cells.
      Objects having relatively small areal spread, such as trees, buildings, bridges, etc., are handled by designated algorithms, and are stored as special points, which enables to stream and display them in the full 3D visual realization.
   Block 154: streaming management unit.
      Continuously updates the data in the computer memory using methods for fast fetch data from database 153, which enables continuous and smooth display of the project, including movement in the project space, using appropriate LOD according to the cell distance from the camera.
      Reference is also made to FIG. 2, which is a schematic illustration of the method of streaming data according to aspects of the present invention. Streaming management subsystem 154 defines region 157 around camera 155 (representing a view point on that region of the project), the data of which are kept in the computer memory. Camera motion is readily enabled in a region 156, which is typically smaller than region 157, without the need to fetch more data into the computer memory. The defined view point defines the direction of axis 158 of camera 155, and thereby defines the region viewed by field of view 159 of camera 155. When the user moves out of region 156, the required data is fetched from database 153 and the computer memory is updated. Simple and fast locating of the data needed to be fetched out of database 153 enables quick and efficient updating of data in the computer memory, and using the appropriate LOD for each cell, provides smooth display of that portion of the project at hand.
      Hence, streaming management sub-system 154 enables efficient utilization of the computer memory, which is typically the main obstacle in tasks performing 3D visual realization of a large scale area.
Block 160: graphic engine.
   While streaming management sub-system 154 loads cells 135a-135k to the system memory, graphic engine 160 selects which data cells 135 and objects that are in the field of view of the camera at any given time. In the example shown in FIG. 2, the following cells are fetched: 135h, 135i and 135k.
   Graphic engine 160 integrates the data cells 135 according to camera 155 location and the defined view point and performs graphical rendering according to the distance and angles of the view point The data is arranged in the Quadtree data structures such that fast fetching can be performed by graphic engine 160. For each fetched object a decision is made as to the displaying and rendering, according to the distance from other objects and the field of view.
   Graphic engine 160 performs a projection of the 2D orthophoto on the 3D model, attaches texture to respective objects, adds lighting features and display the 3D visual realization of the project integrated into the existing geographical neighborhoods in which the project inheres.
   Preferably, graphic engine 160 displays the project at 30 frames per second (FPS) at allow smooth motion visualization.
Block 170: graphic engine user interface.
   Graphic engine user interface 170 performs simulations according to requests made by a user of system 100, such as view points, environment conditions and desired project analysis.
   Graphic engine user interface 170 enables simulation of various weather conditions, various lighting conditions including sun position and thereby display appropriate shading, at any given time.
   Graphic engine user interface 170 enables occlusion-based culling computation, areal and distance computations and presentation and other computations as required.
   Graphic engine user interface 170 enables visualization of a vehicle moving on a road object, controlling all layers of graphical display.

### Principle of Operation

System 100 operatively interfaces thorough interface 110 to the CAD application and converts the design data to the internal structure of data stored in database 140. Missing features are computed according to a set of rules, for example civil engineering rules and various elements of the project are modeled by simulation creation module 120 and 3D simulation models module 130. The visualization definitions and features are set and the terrain is modeled and then stored by data structure creation sub-system 152 in Quadtree data structures in database 153.

Graphic engine 160 streams the data out of database 153, using Streaming management sub-system154. Graphic engine 160 fetches the data cells that are in the field of view of the camera at a given time, and displays the data on the designated media.

Smart management of the computer memory, based on the described Quadtree model, including keeping handy and relevant in the memory, and ability to provide a high frame rate enables smooth display of the 3D visual realization of the project.

The CAD environment and the visualization environment are preferably integrated into one application, enabling performing mutual tasks. Designs and changes made in the CAD space are immediately shown in the 3D visual realization of the project. Problematic locations can be marked in the 3D visual realization space and thereby enable immediate changes in the CAD application to resolve such problems.

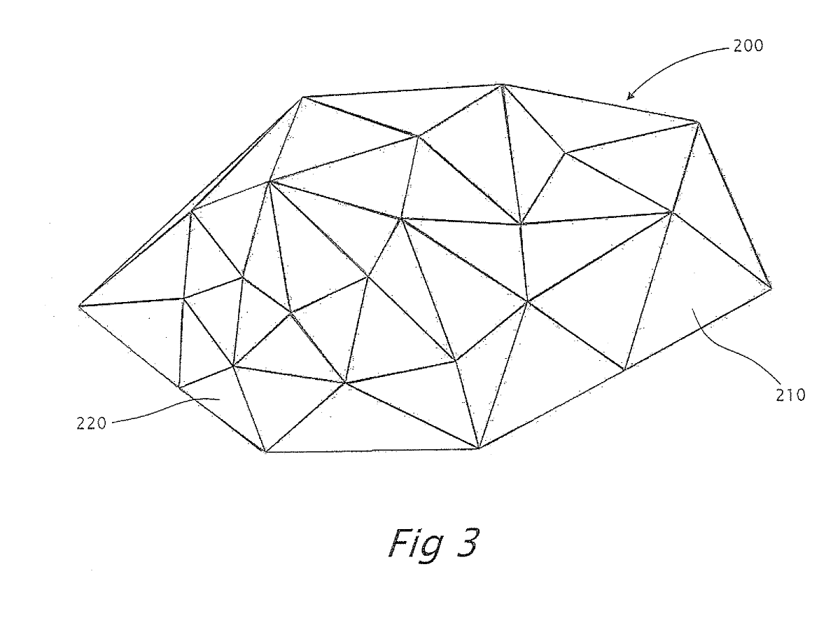

An aspect of the present invention is to provide a method of cutting out one or more selected regions of a topographical mesh and replacing an extracted region with a new topographical design. A topographical mesh is typically represented by a TIN. FIG. 3 depicts an exemplary TIN 200, representing the topography of a selected geographical region. TIN is composed of triangles of different sizes, such as triangles 210 and 220, simulating the topography of a geographical region.

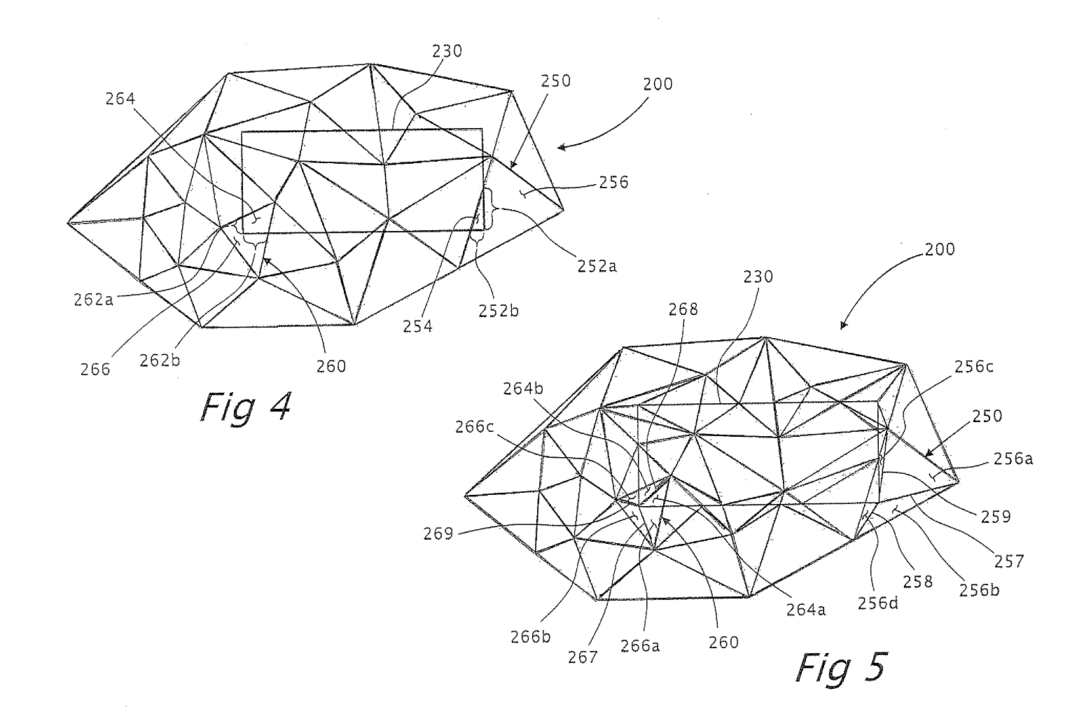

Often, when designing a new feature, such as a road, on a given topographical mesh, the integration of the mesh with the new topographical design results in an unstable graphical display of at least a portion of the integrated region. To overcome the unstable graphical display a new method is provided. The new integration method is described collectively in FIGS. 4-7.

FIG. 4 depicts exemplary TIN 200, wherein the selected region 230, to be replaced by a new topographical design, is marked. FIG. 5 depicts exemplary TIN 200, wherein marked region 230 and its immediate surroundings, are re-triangulated, such that each of all segments composing the boundaries of region 230 become part of two adjacent triangles: a first triangle inside region 230 and a second triangle in the immediate surroundings of the first triangle. The re-triangulation procedure enables a smooth cutting out and smooth implant of the new topographical design. For example, rectangular region 230 breaks triangle 250 (see FIG. 4) into two polygons—polygon 254 and polygon 256. Rectangular region 230 also breaks triangle 260 (see FIG. 4) into two polygons—polygon 264 and polygon 266. Polygon 254, being a triangle, requires no alteration. After the re-triangulation procedure is executed, rib lines 257, 258 and 259 are added inside polygon 256 to form new triangles 256a, 256b, 256c and 256d. In polygon 264, rib line 268 is added to form new triangles 264a and 264b. In polygon 266, rib lines 267 and 269 are added to form new rectangles 266a, 266b and 266c.

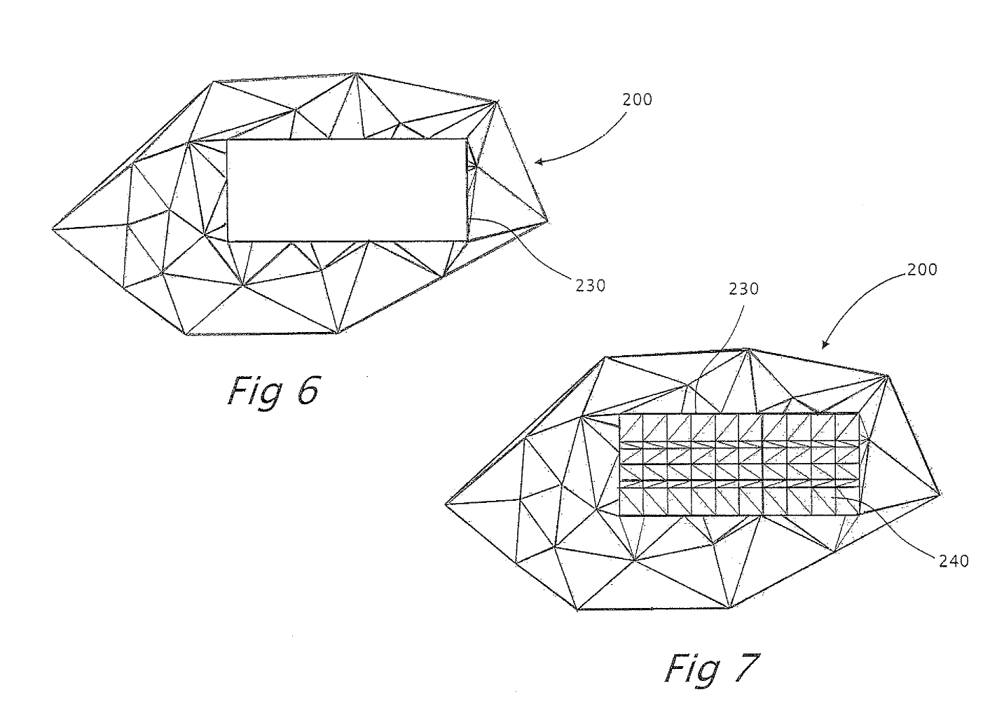

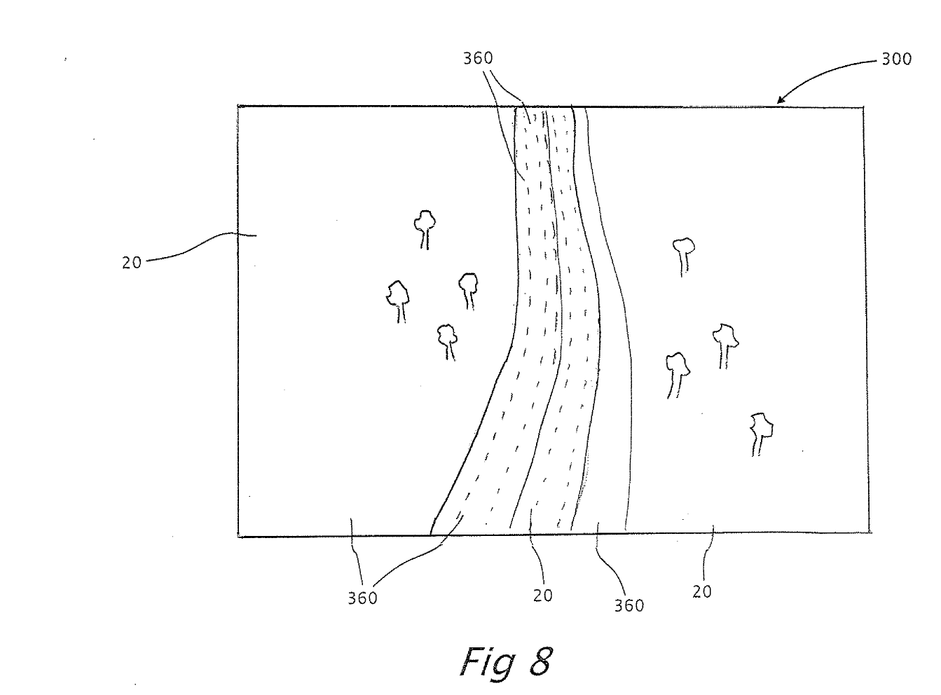

Once the re-triangulation is complete, region 230 can be cut out. FIG. 6 depicts exemplary TIN 200, whereas marked region 230 is cut out. FIG. 7 depicts exemplary TIN 200, wherein a new topographical design 240 is implanted to replace cutout region 230.

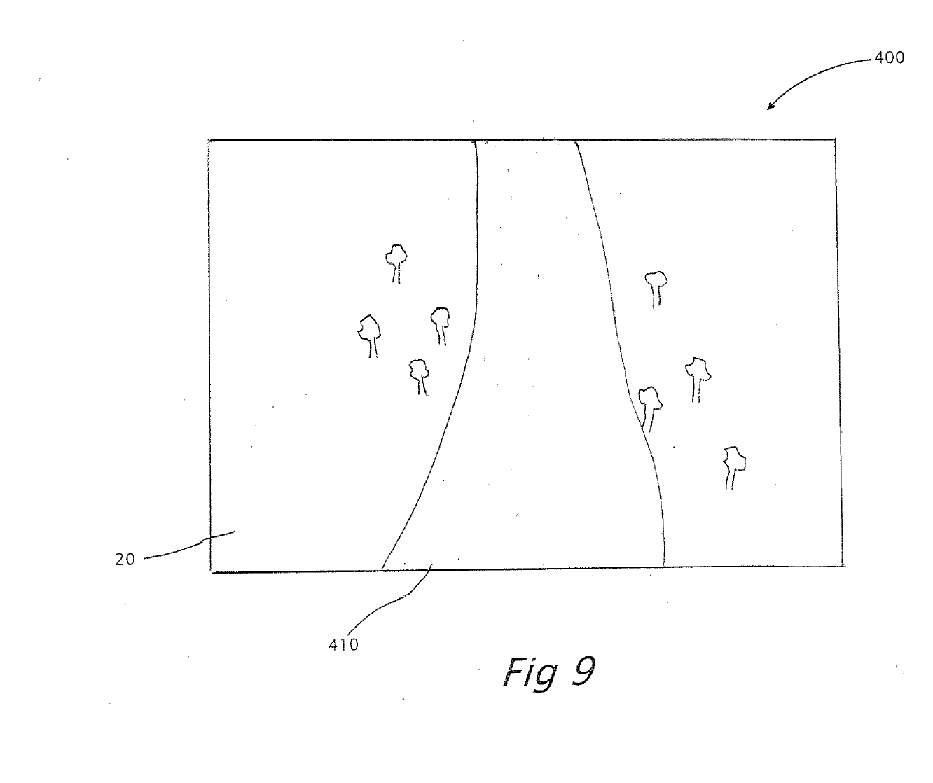

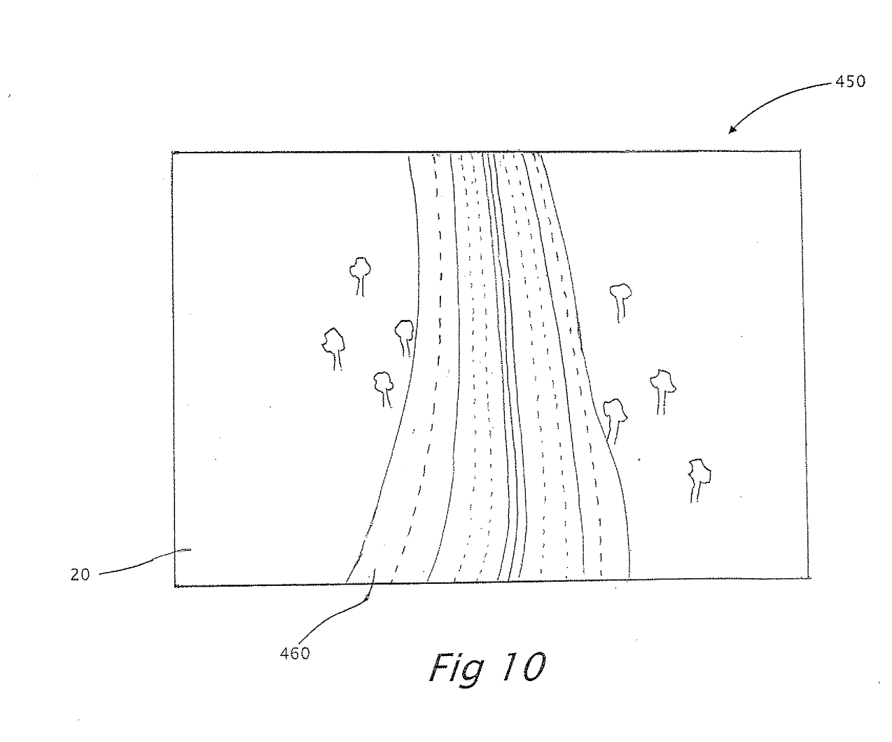

Referring now to FIG. 9, an exemplary topographical model 400, depicting terrain 20 from which a selected region 410 has been cut out, is shown. FIG. 10 depicts the cutout mesh shown in FIG. 9, wherein a new topographical design 460 is implanted to replace cutout region 410, forming a new topographical model 450. In this example, a new road is designed including cutting through hills and filling ravines.

The invention being thus described in terms of several embodiments and examples, it will be obvious that the same may be varied in many ways. Such variations are not to be regarded as a departure from the spirit and scope of the invention, and all such modifications as would be obvious to one skilled in the art.

What is claimed is:

1. A 3D visual realization system for a civil engineering project operatively connected to a CAD system, the system comprising:
(a) simulation creation module;
(b) a 3D surface simulation module;
(c) a Quadtree based 3D surface models database;
(d) a data managing sub-system comprising:
i. a data structure creation unit; and
ii. streaming management unit; and
(e) a graphic engine,
wherein a triangulated irregular network (TIN) model of the neighborhood, in which said civil engineering project inheres, is created by said 3D surface simulation module from said CAD system;
wherein said data structure creation unit manages the integrity of said TIN model;
wherein said civil engineering project is simulated by said simulation creation module, thereby creating a simulated surface model of said civil engineering project stored in said models database; and
wherein said TIN model and said simulated surface model of said civil engineering project are streamed into said graphic engine to create an integrated surface model of said civil engineering project

2. The system as in claim 1 further comprising:
(f) a user interface for said graphic engine, wherein said user interface performs simulations according to requests made by a user of said system performing said method.

3. A method of 3D visual realization system for a civil engineering project, the method comprising the steps of:
(a) providing a CAD system;
(b) computing a triangulated irregular network (TIN) model of the neighborhood in which said civil engineering project inheres;
(c) computing a TIN model of said civil engineering project;
(d) forming a Quadtree representation of said neighborhood TIN model;
(e) streaming said Quadtree representation of said neighborhood TIN model with said TIN model of said civil engineering project into a graphic engine; and
(f) computing an integrated surface model of said civil engineering project by said graphic engine, thereby creating an integrated surface model of said civil engineering project.

4. The method as in claim 3 further comprising the step of:
(g) providing a graphic engine user interface, wherein said graphic engine user interface performs simulations according to requests made by a user.

5. The 3D visual realization system as in claim 3, wherein said computing of an integrated surface model of said civil engineering project by said graphic engine includes the steps of:
(a) selecting at least a portion of said TIN model of said civil engineering project, thereby obtaining a TIN model of a civil engineering design;
(b) determining the form and dimensions of the external contour formed by the boundaries of said TIN model of said civil engineering design;
(c) determining the target position of said TIN model of said civil engineering design on said TIN model of said civil engineering project;
(d) marking said external contour of said TIN model of said civil engineering design at said target position on said TIN model of said civil engineering project, thereby creating a selected region;
(e) retriangulating the neighborhood TIN model of said selected region to fit in said selected region;
(f) cutting out the internal portion of said selected region of said TIN model of said civil engineering design from said TIN model of said civil engineering project; and
(g) merging said TIN model of said civil engineering design at said target position of said TIN model of said civil engineering project.
